(19) United States
(12) Patent Application Publication
(10) Pub. No.: US 2017/0220383 A1
(43) Pub. Date: Aug. 3, 2017

(54) WORKLOAD CONTROL IN A WORKLOAD SCHEDULING SYSTEM

(71) Applicant: CA, INC., New York, NY (US)

(72) Inventor: APURV RAJ, Hyderabad (IN)

(73) Assignee: CA, INC., NEW YORK, NY (US)

(21) Appl. No.: 15/370,795

(22) Filed: Dec. 6, 2016

Related U.S. Application Data
(63) Continuation-in-part of application No. 15/008,509, filed on Jan. 28, 2016.

(51) Int. Cl. G06F 9/50; G06F 9/48

(52) U.S. Cl. CPC G06F 9/505; G06F 9/4887

(57) ABSTRACT

A method includes receiving, at a workload agent, a plurality of jobs for processing by the workload agent; determining a maximum amount of time that the workload agent should take to process the jobs; and processing the jobs within the determined maximum amount of time. The maximum amount of time that the workload agent should take to process the jobs may be determined based on a number of jobs received and a throughput of the workload agent.

### RELATED APPLICATION

The present application is a continuation-in-part of U.S. application Ser. No. 15/008,509, filed Jan. 28, 2016, entitled “Weight Adjusted Dynamic Task Propagation,” (Atty Docket No. 1100-160001), the disclosure of which is incorporated herein by reference in its entirety.

### BACKGROUND

The present disclosure relates to data processing systems, and in particular, to the scheduling of jobs in data processing systems.

Data processing systems utilize scheduling engines to schedule execution of computer processes. Scheduling the execution of computer processes is often referred to as job management, which may involve scheduling a computer process to occur at one designated time, repeatedly at periodic times, or according to other time schedules. Numerous scheduling engines exist today, such as Unicenter CA-7, Unicenter CA-Scheduler, and Unicenter CA-Job track available from Computer Associates.

In a distributed computing platform that includes many different data processing devices, such as a multi-server cluster, job scheduling is an important task. Distributed computing platforms typically include software that allocates computing tasks across a group of computing devices, enabling large workloads to be processed in parallel.

Cloud computing/storage environments have become a popular choice for implementing data processing systems. In a cloud computing/storage environment, a cloud provider hosts hardware and related items and provides systems and computational power as a service to a customer, such as a business organization.

Cloud computing/storage environments may support virtual machines (VM), which are emulations of physical machines implemented in software, hardware, or combination of both software and hardware. In a cloud computing environment, jobs may be delegated to virtual machines. Virtual machine resources may be scheduled in a similar manner as physical machine resources. Thus, a distributed computing platform may consist of physical machines, virtual machines, or a collection of both physical and virtual machines.

Entities to which tasks, or jobs, are assigned by a scheduler are generally referred to as “agents” or “workload agents,” and may reside on physical machines and/or virtual machines.

### SUMMARY

Some embodiments of the present disclosure are directed to a method of assigning data processing tasks to workload agents. A method includes receiving, at a workload agent, a plurality of jobs for processing by the workload agent; determining a maximum amount of time that the workload agent should take to process the jobs; and processing the jobs within the determined maximum amount of time. The maximum amount of time that the workload agent should take to process the jobs may be determined based on a number of jobs received and a throughput of the workload agent.

The maximum amount of time that the workload agent should able to process the jobs may be calculated as ProcTimeY=max(ProcTimeY, ElapsedTimeY)+(NJobsY/ThroughputX), where ProcTimeY represents a maximum amount of time that the workload agent should take to process jobs received from a source Y, ElapsedTimeY is an elapsed time since ProcTimeY was reset, NJobsY is a number of jobs submitted by source Y that are currently being handled by the workload agent and ThroughputX is a throughput of the workload agent.

The value of ThroughputX may include a workload capacity of the workload agent to execute jobs plus a rate at which the workload agent can forward jobs to a downstream agent.

The method may further include resetting a value of ProcTimeY to zero in response to all jobs from source Y being either processed such that no remaining jobs from source Y are currently being handled by the workload agent.

The method may further include updating a value of ProcTimeY as jobs are received and processed.

The source Y may be a first source, and the method may further include determining a maximum amount of time that the workload agent should take to process jobs received from a second source X as: ProcTimeX=max(ProcTimeX, ElapsedTimeX)+(NJobsX/ThroughputX), where ProcTimeX represents a maximum amount of time that the workload agent should take to process jobs received from the second source X, ElapsedTimex is an elapsed time since ProcTimeX was reset, and NJobsX is a number of jobs submitted by the second source X that are currently being handled by the workload agent.

The method may further include comparing a value of ProcTimeX to a value of ProcTimeY, and preferentially processing jobs submitted by the source having the largest value of ProcTime.

The method may further include, if the value of ProcTimeX is equal to the value of ProcTimeY, comparing values of ElapsedTimeX and ElapsedTimeY and preferentially processing jobs submitted by the source having the largest value of ElapsedTime.

A method according to further embodiments includes receiving, at a workload scheduler, a plurality of jobs to be scheduled for execution by a workload agent; determining a current throughput of the workload agent; determining a first total number of jobs that are available to be scheduled for execution by the workload agent; determining a second total number of jobs that can be processed by the workload agent within a predetermined time period based on the current throughput of the workload agent; comparing the first total number of jobs and the second total number of jobs; and scheduling a lesser of the first total number of jobs and the second total number of jobs for execution by the workload agent for execution within the predetermined time period.

Comparing the first total number of jobs and the second total number of jobs may include calculating a value as: RcvdN=min(ElapsedTimeN*ArrivalRateN+NQueuedN, ThroughputN*T), where ElapsedTimeN is an elapsed time since RcvdN was updated, ArrivalRateN is an average arrival rate of jobs to be scheduled at the workload agent, NQueuedN is a number of jobs previously queued for execution by the workload agent, ThroughputN is a throughput of the workload agent, and T is a time period over which jobs will be scheduled.

The method may further include updating a value of RcvdN as jobs are scheduled for execution by the workload agent.

A method according to further embodiments includes receiving at a primary workload agent, via a communication network, a job to be executed by the primary workload agent; receiving a plurality of workload parameters for a plurality of workload agents, wherein the workload parameters relate to available capacities of the plurality of workload agents and wherein the workload agents comprise computing nodes configured to perform data processing tasks; identifying a plurality of candidate secondary workload agents from among the plurality of workload agents; identifying a secondary workload agent from among the plurality of candidate secondary workload agents based on the plurality of workload parameters; and transmitting, via the communication network, a job message that contains a command for the secondary workload agent to perform a data processing task, wherein the job message includes a forwarding map that identifies the primary workload agent and that instructs the secondary workload agent to perform the data processing task.

Identifying the plurality of candidate secondary workload agents may include determining path lengths from the primary workload agent to the plurality of workload agents based on a number of communication nodes between the primary workload agent and each of the plurality of workload agents, and selecting workload agents having a path length to the primary workload agent that is less than a threshold path length as the candidate secondary workload agents.

Identifying the secondary workload agent may include evaluating a selection function that mathematically evaluates the workload parameters.

The selection function may include a weight adjusted function of the plurality workload parameters.

The plurality of workload parameters may include an available CPU metric, an available memory metric, an available workload capacity metric, and/or an available throughput metric.

Evaluating the selection function may include selecting a workload agent from among the candidate secondary workload agents that maximizes a weight adjust factor (WAF) output by a function based on:

$$WAF = \sqrt{\frac{{w}_{1} {M}_{1}^{2} + {w}_{2} {M}_{2}^{2} + {w}_{3} {M}_{3}^{2} + … + {w}_{N} {M}_{N}^{2}}{{w}_{1} + {w}_{2} + {w}_{3} + … + {w}_{N}}}$$

where M1 . . . MN are workload parameters, w1 . . . wN are weights assigned to the respective workload parameters.

Identifying the candidate secondary workload agents may include identifying workload agents for which each of the workload parameters is greater than a respective threshold level.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a workload scheduling computer according to some embodiments of the inventive concepts.

FIG. 3 is a block diagram illustrating workload scheduling according to some embodiments of the inventive concepts.

FIG. 5 is a table illustrating an example of workload control by a workload agent according to some embodiments.

FIGS. 6A-6B are flowcharts illustrating operations of systems/methods in accordance with some embodiments of the inventive concepts.

FIG. 7 is a table illustrating an example of workload control by a scheudliner according to some embodiments.

FIGS. 8A-8B are flowcharts illustrating operations of systems/methods in accordance with some embodiments of the inventive concepts.

FIGS. 9-12 are flowcharts illustrating operations of systems/methods in accordance with some embodiments of the inventive concepts.

FIG. 13 is a block diagram of a computing system which can be configured as a workload scheduling computer according to some embodiments of the inventive concepts.

FIG. 14 is a block diagram of a computing node which can be configured as a workload agent according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As discussed above, in a distributed computing environment, a scheduler may assign various tasks to one or more workload agents. Workload agents, whether they are implemented in physical or virtual machines, have a finite capacity for handling assigned workloads based on the amount of resources, such as processor capacity, memory, bandwidth, etc., available to the workload agent. Moreover, the resources available to a virtual agent may change dynamically, as the resources may be shared by other virtual machines hosted on the same physical server as the agent.

Conventionally, if a scheduler assigns a job to a workload agent and the workload agent does not have capacity to perform the job, either the job will be queued until the workload agent has capacity or the workload agent will return an error in response to the assignment. In either case, execution of the job is delayed, and the scheduler may incur additional overhead associated with the job.

In more advanced systems, a workload agent may forward jobs to another workload agent in the event the forwarding workload agent does not have capacity to perform the job. This may enable the forwarding workload agent to share the workload if agent's computing capacity is exceeded. This in turn enables workload agents to scale their capacity in a scheduler-agent environment without disrupting operation of the scheduler by increasing the overhead load on the scheduler.

However, workload agents can become overloaded even in systems in which agents can forward jobs to other agents. Some embodiments described herein can help to avoid saturation of workload agents so that workloads can be managed without causing degradation in system performance. In addition, some embodiments can help to maintain minimum performance levels in a distributed computing environment.

Some embodiments help to control saturation/congestion in a distributed computing environment at both the agent level and the scheduler level. At the agent level, systems/methods according to some embodiments help to control congestion by equally distributing the processing time that each workflow agent allocates to jobs. At the scheduler level, some embodiments limit the flow of jobs to particular agents based on the agents' throughput.

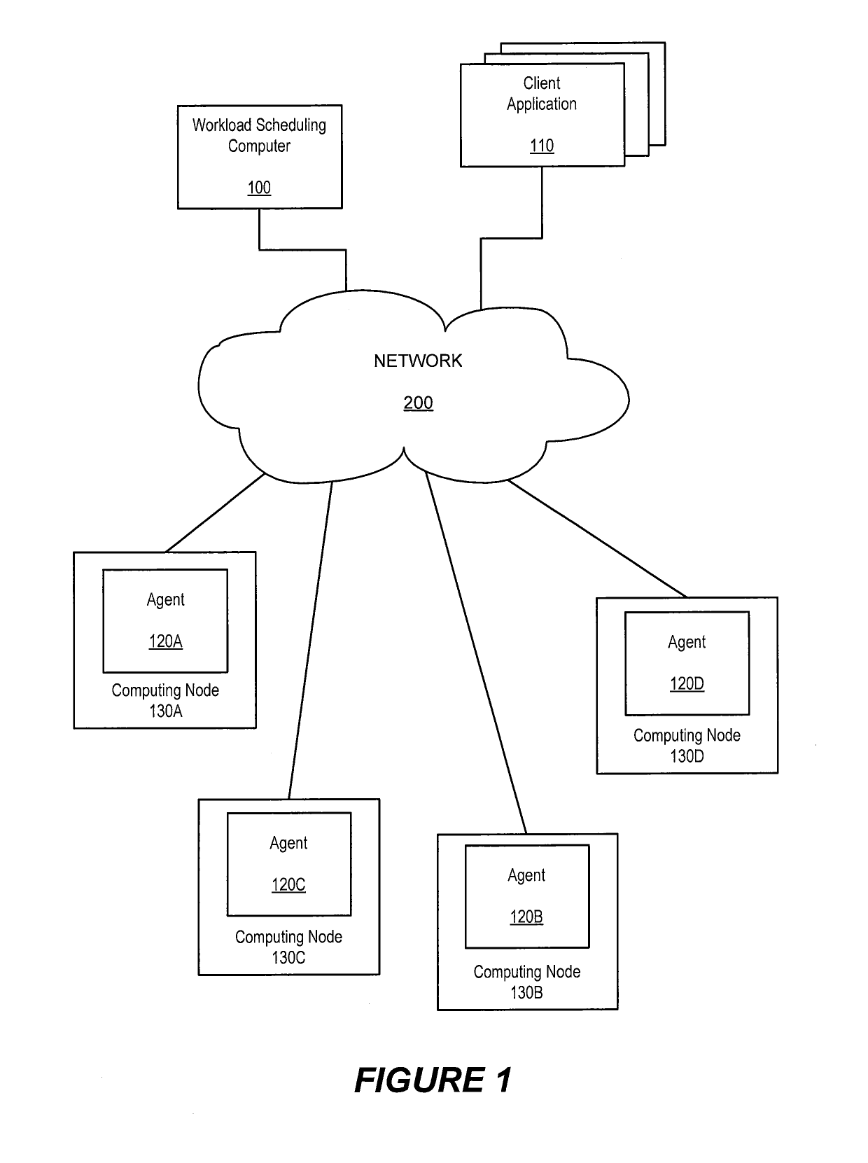

FIG. 1 is a block diagram of a distributed computing environment in which systems/methods according to embodiments of the inventive concepts may be employed. Referring to FIG. 1, a plurality of computing nodes 130 are provided. The computing nodes may be physical devices, such as servers that have processors and associated resources, such as memory, storage, communication interfaces, etc., or virtual machines that have virtual resources assigned by a virtual hypervisor. The computing nodes communicate over a communications network 200, which may be a private network, such as a local area network (LAN) or wide area network (WAN), or a public network, such as the Internet. The communications network may use a communications protocol, such as TCP/IP, in which each network node is assigned a unique network address, or IP address.

Each of the computing nodes 130 may host one or more workload agents 120 (or simply agents 120), which are software applications configured to process jobs assigned by a workload scheduling computer 100. The workload scheduling computer 100 may be referred to herein as a “workload scheduler,” or more simply a “scheduler” 100. In the distributed computing environment illustrated in FIG. 1, jobs are requested by client applications 110. A job request may be sent by a client application 110 to the scheduler 100. The scheduler 100 in turn distributes the job to one of the available workload agents 120 based on one or more parameters.

A workload agent 120, such as workload agent 120A, may receive a job assignment from the scheduler 100, perform the job, and return a result of the job to the scheduler 100, or alternatively to the client application 110 that requested the job. In other embodiments, the client application may submit the job to a job manager (not shown), that may split the job into a plurality of sub-tasks, and request the scheduler 100 to assign each of the individual sub-tasks to one or more workload agents for completion.

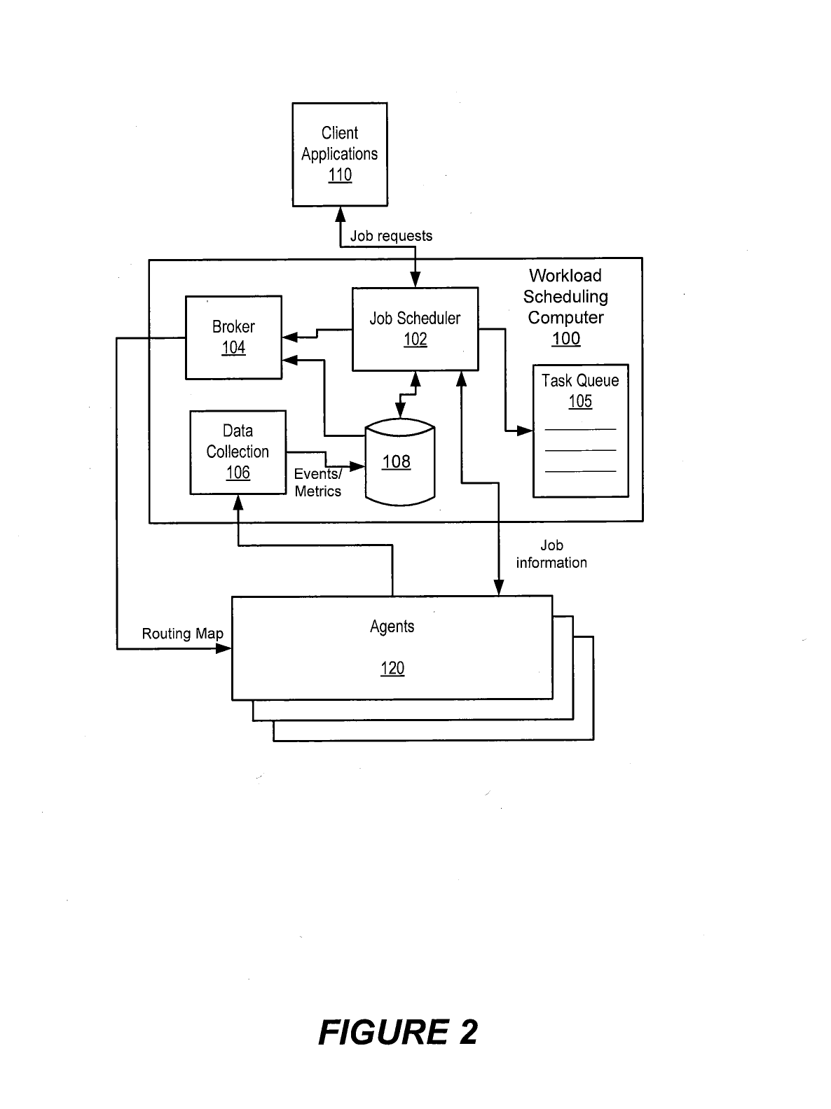

FIG. 2 is a block diagram of a workload scheduling computer 100 according to some embodiments showing components of the workload scheduling computer 100 in more detail. The workload scheduling computer 100 includes various components that communicate with one another to perform the workload scheduling function. For example, the workload scheduling computer 100 includes a job scheduler component 102, a task queue 105, a database 108, a broker component 104, and a data collection component 106. It will be appreciated that the workload scheduling computer 100 may be implemented on a single physical or virtual machine, or its functionality may be distributed over multiple physical or virtual machines. Moreover, the database 108 may be located in the workload scheduling computer 100 or may be accessible to the workload scheduling computer 100 over a communication interface.

Client applications 110 submit job requests to the workload scheduling computer 100. The job requests are forwarded to the job scheduler component 102 for processing. The job scheduler component 102 uses the task queue to keep track of the assignment and status of jobs. The job scheduler transmits job information to workload agents 120 for processing, and may also store information about jobs in the database 108.

Information about the status of workload agents, such as the available workload capacity of workload agents, is collected by the data collection component 106 and stored in the database 108, which is accessible to both the job scheduler 102 and the broker component 104. The data collection component 106 also collects information about events relating to jobs and metrics provided by workload agents and stores such information in the database 108. The job-related events may include job status information (queued, pending, processing, completed, etc.) and/or information about the workload agents, such as whether a workload agent is available for scheduling, is being taken offline, etc.

The broker component 104 provides routing map information directly to the workload agents 120. The routing map information may be provided along with job information or independent from the job information. As will be discussed in more detail below, the routing map information identifies secondary, tertiary, and possibly other workload agents to which jobs should or may be forwarded by a workload agent, acting in that case as a primary workload agent.

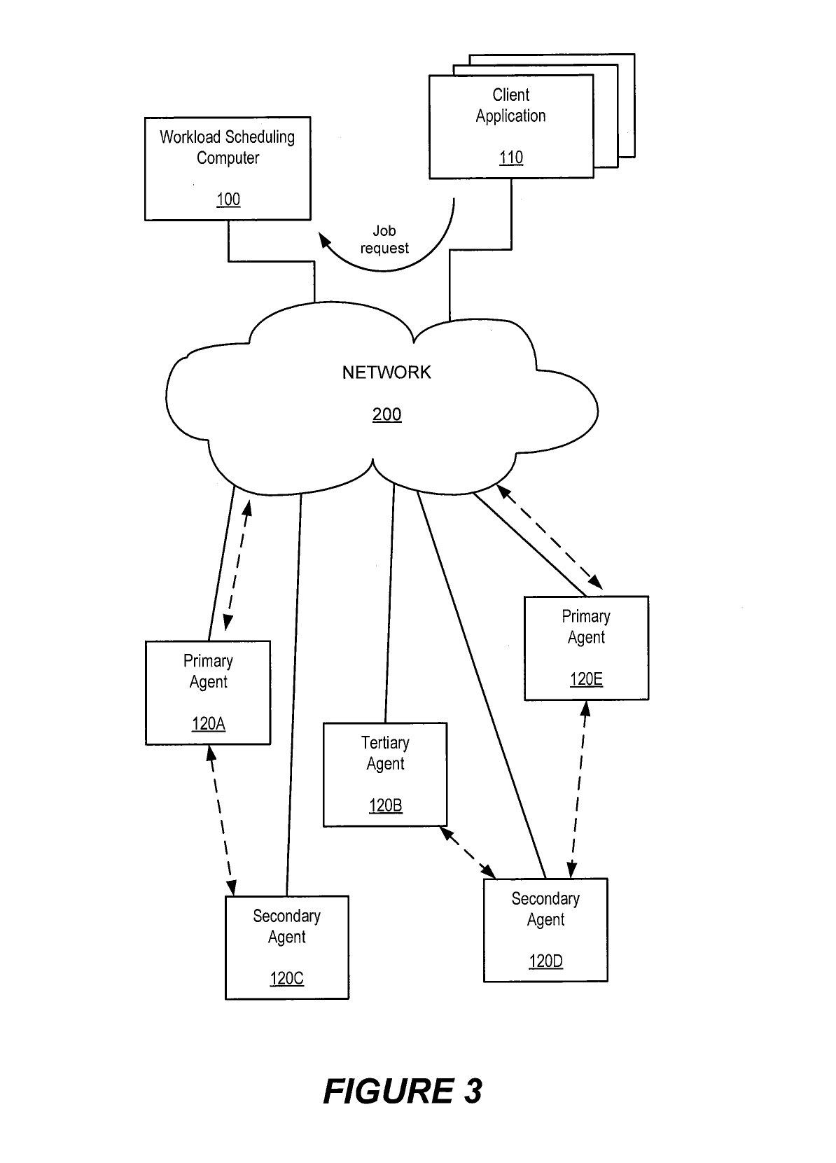

FIG. 3 is a block diagram illustrating the use of routing maps to forward jobs in a distributed computing environment. Referring to FIGS. 2 and 3, a client application 110 sends a job request to the workload scheduling computer 100. The job scheduler component 102 of the workload scheduling computer 100 receives the job request and consults the task queue to determine which workload agents are available to perform the job. The job scheduler component 102 selects a workload agent 120 to perform the job, and may transmit job information directly to the selected agent. The selected agent in this case is referred to as the primary workload agent.

The job scheduler component 102 may also transmit the job information to the broker component 104, which forwards a routing map to the primary workload agent 120 as discussed in more detail below. In some embodiments, the broker component 104 may receive the job information from the job scheduler component 102 and send the routing map to the primary workload agent together with the job information. In still other embodiments, the broker component 104 may transmit the routing map to the job scheduler component 102, and the job scheduler component 102 sends the routing map to the primary workload agent together with the job information.

The routing map transmitted to the primary workload agent 120A (along with the job information or separately from the job information), may identify a secondary workload agent 120C to which the primary workload agent 120A can or must forward the job for execution. That is, in some embodiments, the primary workload agent 120A acts as a “dumb terminal” and simply forwards the job to the secondary workload agent 120E identified in the routing map upon receipt of the routing map. In other embodiments, the primary workload agent 120A may forward the job to the secondary workload agent 120E on an as needed basis, such as when the primary workload agent 120A determines that it does not have the resources to complete a job, when the primary workload agent determines that it is going down due to an exception, or in other conditions.

In some embodiments, the routing map may identify a tertiary agent to which the secondary workload agent can or shall forward the job for execution. For example, as shown in FIG. 3, job information and a routing map may be transmitted by the workload scheduling computer 100 to a primary workload agent 120E. The routing map may identify a secondary workload agent 120D to which the primary workload agent 120E can or shall forward the job, and may also identify a tertiary agent 120B to which the secondary workload agent 120D can or shall forward the job for execution.

In this manner, the workload agents may scalably extend their resources without additional intervention of the workload scheduling computer 100. The approach described herein may help in attempts to optimize the capacity of a multi-agent environment. As will be discussed in more detail below, routing maps may be generated based on available workload agent capacities as well as job parameters.

Systems/methods for forwarding jobs in a distributed computing environment are described in detail in U.S. application Ser. No. 15/008,509, filed Jan. 28, 2016, entitled “Weight Adjusted Dynamic Task Propagation,” (Atty Docket No. 1100-160001), the disclosure of which is incorporated herein by reference in its entirety.

Referring again to FIG. 2, the broker component 104 of the workload scheduling computer 100 may monitor the capacities of the subscribed workload agents, and may determine that a secondary workload agent should be assigned to a particular workload agent for the performance of a particular task. In particular, the broker component may receive a plurality of workload parameters from a plurality of workload agents. The workload parameters relate to available capacities of the plurality of workload agents, and may include parameters such as workload capacity, available CPU percentage, available memory, and/or available throughput. The parameters may be indicated by metrics, which may be absolute, relative, percentage, or any other suitable measure.

In this context, “workload capacity” means how many jobs can be processed by system in a given unit of time while maintaining a predetermined quality of service, such as a predetermined response time. For example, a particular workload agent can process 100 incoming jobs per second (i.e., 6000 jobs/hour or 1,44,000 jobs/day) while meeting a predetermined response deadline for each job, then workload capacity of the agent is at least 100 jobs per second.

The workload parameters may be collected by the data collection component 106 of the workload scheduling computer 100, and stored in the database 108, from which they can be accessed by the broker component 104 and/or the job scheduler component 102.

When a job is to be scheduled, the broker component 104 may identify a primary workload agent from the plurality of subscribed workload agents based on one or more of the plurality of workload parameters. The broker component 104 may also identify a plurality of candidate secondary workload agents from among the plurality of workload agents.

The broker component 104 may then identify a secondary workload agent from among the plurality of candidate secondary workload agents based on the plurality of workload parameters. Once the secondary workload agent has been identified, the job scheduler 102 or the broker component 104 builds a forwarding map to be transmitted to the primary workload agent along with a job request.

The broker component 104 may then transmit a job scheduling message that contains a command for the primary workload agent to perform a data processing task. The job scheduling message includes a forwarding map that identifies the secondary workload agent. By including the forwarding map in the job request, the job message contains a command for the primary workload agent to perform the data processing task using resources of the secondary workload agent.

To determine whether to include a forwarding map with a job request, the broker component may identify which of the workload agents has a workload capacity below a predefined threshold. Thus, when a job is sent to one of the workload agents having a workload capacity below the threshold, the job request may include a forwarding map. In other embodiments, a forwarding map may be included with each job request.

According to some embodiments, a workload agent may be configured to maintain a minimum job forwarding rate to make sure that the workload agent is not holding on to jobs that the agent is not able to process itself. In this way, the system ensures that each agent is either processing or forwarding jobs at a minimum rate.

### Managing Processing Times at Workload Agents

According to some embodiments, each workload agent 120 maintains a variable, ProcTime, for each agent from which the workload agent can receive forwarded jobs. The ProcTime variable represents a maximum amount of time that the workload agent 120 should take to process a request from a neighboring workload agent.

The ProcTime variable has two components. The first component takes into account the total amount of time that has elapsed since the variable was last reset to zero. The second component takes into account the total number of jobs submitted by the relevant agent, as well as the workload capacity of the receiving agent. Accordingly, the ProcTime variable defined at agent X for jobs forwarded to agent X by agent Y may have the following form:

ProcTime_{Y}=max(ProcTime_{Y},ElapsedTime_{Y})+(NJobs_{Y}/Throughput_{X}) [1.1]

where ElapsedTime_{Y} is the elapsed time since the ProcTime_{Y} variable was reset, NJobs_{Y} is the number of jobs submitted by agent Y that are currently being handled by agent X (i.e., that have been submitted but not already processed or forwarded) and Throughput_{X} is the throughput of agent X, which includes the workload capacity of agent X to execute jobs plus the rate at which agent X can forward jobs to a downstream agent. The ProcTime variable maybe reset to zero when the number of jobs that are currently being handled by the agent drops to zero. Thus, for example, when the NJobs_{Y} variable drops to zero (because the agent has either executed or forwarded all jobs that were received from agent Y), the ProcTime_{Y} variable is reset to zero.

In situations where jobs received from agent Y have been queued, the value of ProcTimeY may have the following form:

ProcTime_{Y}=ProcTime_{Y}+(NJobs_{Y}/Throughput_{X}) [1.2]

The workload agent that is receiving jobs (agent X in this example), maintains a ProcTime variable for each agent from which it receives forwarded jobs. At any given instant, the workload agent will process jobs received from the forwarding agent for which the ProcTime variable is the highest. If the values of ProcTime are equal, jobs are preferentially processed from the agent having the largest value of ElapsedTime.

For example, referring to FIG. 4, assume that a secondary agent (Agent C) 120C, is configured to receive and process jobs forwarded from primary agents Agent A 120A and Agent B 120B. Assume further that Agent C is configured to forward jobs to a tertiary agent, Agent X 120X. Agent C will maintain a ProcTime variable for both upstream agents, Agent A and Agent B. These variables may be denoted ProcTime_{A} and ProcTime_{B}. In this example, Agent A and Agent B are upstream agents, or forwarding agents, while Agent C is the processing agent and Agent X is a downstream agent.

In some embodiments, the ProcTime variable may be associated both with an upstream agent that forwards jobs to the processing agent as well as with a downstream agent. The processing agent may keep track of processing times associated with both upstream and downstream agents. Thus, ProcTime_{A} may be denoted as ProcTime_{AX}, and ProcTime_{B} may be denoted as ProcTime_{BX}. However, for simplicity, the notations ProcTime_{A} and ProcTime_{B} will be used in the following discussion.

As noted above, the ProcTime variable starts at 0 at initialization, and is updated every time the processing agent receives a new request from the upstream agent including new jobs for processing.

The ProcTime_{A} and ProcTime_{B} variables are continuously updated as jobs are processed and new jobs are received. Because the processing agent processes jobs from the upstream agent having the largest value of ProcTime, the processing agent ensures that it is processing all workloads with at least a minimum allocation of processing time.

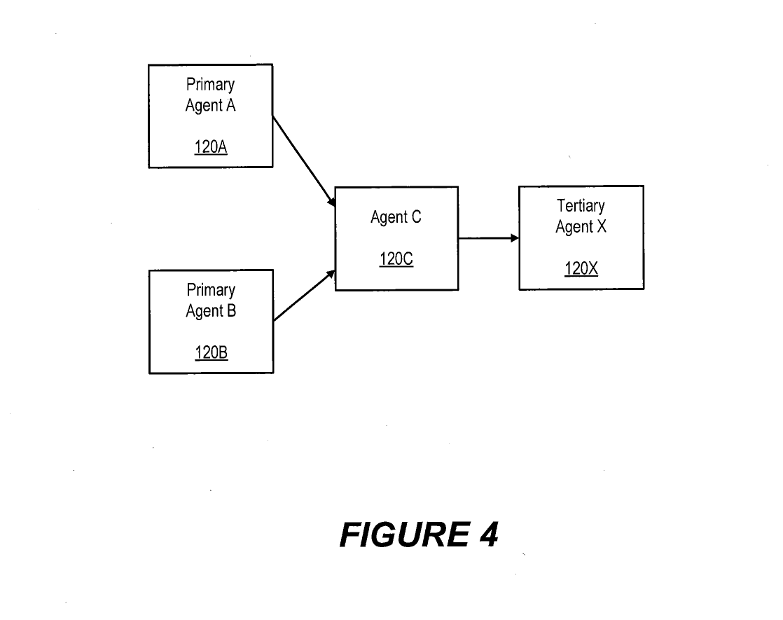

An example of the use of ProcTime variable for workload allocation is shown in the table of FIG. 5. In the example of FIG. 5, a processing agent (Agent C) processes jobs forwarded by Agents A and B. In this example, Agent C has a total throughput capacity of 100 jobs per second. In this example, the processing time unit is one second. Thus, in this example, the ProcTime variables are updated once per second. However, other time intervals could be used without departing from the scope of the inventive concepts.

The processing agent keeps track of ProcTime_{A} and ProcTime_{B} (shown in the table as PT/A and PT/B). The processing agent also keeps track of the elapsed time since each ProcTime variable was reset to zero (shown in the table as ET/A and ET/B). Each time new jobs are received and processed, the ProcTime variables are updated, and the processing agent determines which agent's jobs to process next by comparing the ProcTime variables.

For example, referring to FIG. 5, in the example, when Agent C initializes at time t=0, Agent C receives 100 new jobs from Agent A and 200 new jobs from Agent C. Because Agent C has just initialized, Agent C therefore has a total number of 100 jobs pending from Agent A and 200 jobs pending from Agent B. The ProcTime variables PT/A and PT/B are initially zero. The ProcTime variables are updated in response to the new jobs from Agent A and Agent B using the formulas in equations [1.1] and [1.2] above. Using equation [1], for Agent A, ProcTime_{A} evaluates to 1, while for Agent B, ProcTime_{B} evaluates to 2. Thus, because ProcTime_{B}>ProcTime_{A}, Agent C will execute or forward 100 jobs for Agent B in the next second (recall that Agent C has a throughput of 100 jobs/second).

At time t=1, no new jobs have been received from Agent A or Agent B. Thus, the total number of jobs pending for Agent A is 100, and the total number of jobs pending for Agent B is 100. Agent C updates the ProcTime variables using equations [1.1] and [1.2]. At t=1, ProcTime_{B} evaluates to 3, while ProcTime_{A} evaluates to 2. Thus, Agent C again executes the pending jobs from Agent B, which represents remaining 100 jobs from Agent B. Since all of the jobs from Agent B have been processed, ProcTime_{B} is reset to zero.

Again at time t=2, no new jobs have been received from Agent A or Agent B. Thus, the total number of jobs pending for Agent A is 100, and the total number of jobs pending for Agent B is 0. Agent C again updates the ProcTime variables using equations [1.1] and [1.2]. At t=2, ProcTime_{B} evaluates to 0, while ProcTime_{A} evaluates to 3. Thus, Agent C again executes the pending jobs from Agent A, which represents the pending 100 jobs. Since all of the jobs from Agent A have now been processed, ProcTime_{A} is reset to zero.

The example shown in FIG. 5 further indicates that, at time t=3, 100 jobs are received from Agent A and 200 jobs are received from Agent B. The ProcTime variables are re-calculated according to equations [1.1] and [1.2], and 100 jobs from Agent B are processed.

At time t=4, however, 400 new jobs are received from Agent A. At this time, ProcTime_{A} evaluates to 6, while ProcTime_{B} evaluates to 3. Thus, at this time interval, Agent C processes the next 100 jobs from Agent A. This process continues until all jobs from both agents have been processed.

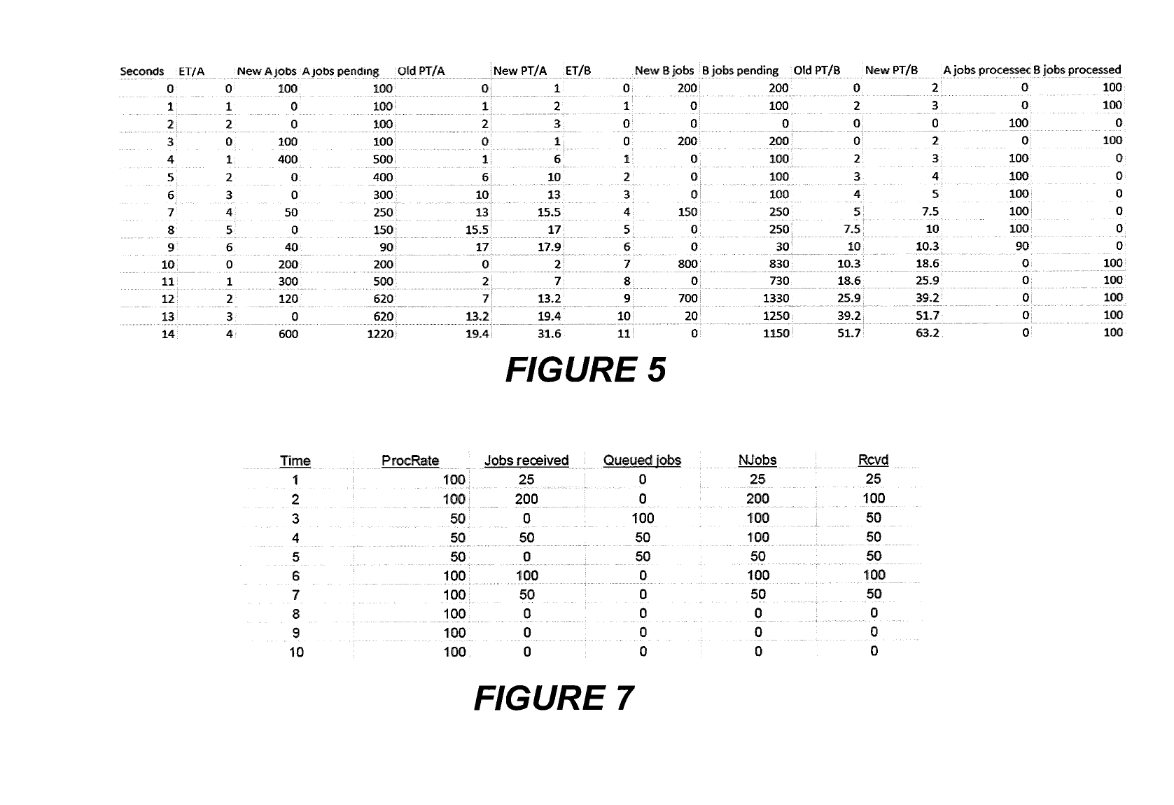

FIG. 6A is a flowchart of operations of a workload agent for managing processing times according to some embodiments. Referring to FIG. 6B, an agent that is configured to receive, execute and forward jobs from a scheduler receives a plurality of jobs for execution or forwarding from a source (Block 602). The agent then determines a maximum amount of time that it should take to execute or forward the jobs (Block 604). Finally, the agent either executes or forwards the jobs within the determined maximum amount of time.

In some embodiments, the agent receives jobs from multiple sources. The agent may execute or forward jobs from multiple sources by determining a maximum amount of time for executing or forwarding jobs from each source and comparing the determined maximum amounts of time. For example, referring to FIG. 6B, an agent may receive jobs for execution or forwarding from a first source and a second source (Block 612). The operations then determine, for each source, a maximum amount of time for executing or forwarding jobs (Block 614). The operations then compare the determined maximum amounts of time (Block 616) and preferentially execute or forward jobs received from the source for which the determined maximum amount of time is the largest (Block 618).

### Managing Workloads at Workload Agents

According to some embodiments, in conjunction with managing processing times at the workload agents, the scheduler actively manages the job flow to individual workload agents based on the throughputs of the workload agents. The scheduler accomplishes this by maintaining a variable for each workload agent that represents the ability of the workload agent to process new jobs.

For example, the scheduler may maintain a variable Rcvd_{N} for workload agent N. The variable Rcvd_{N} takes into account the incoming arrival rate of jobs to agent N as well as the throughput of agent N, and is updated based on the number of jobs that are submitted to agent N in each time interval. Thus, for example, when the scheduler has jobs to be scheduled at agent N, the scheduler may calculate a value of Rcvd_{N} as follows:

Rcvd_{N}=min(ElapsedTime_{N}*ArrivalRate_{N}+NQueued_{N},Throughput_{N}*T) [2]

where ElapsedTime_{N} is the elapsed time since Rcvd_{N} was updated, ArrivalRate_{N} is the average arrival rate of jobs to be scheduled at Agent N, NQueued_{N} is the number of jobs previously queued for execution by Agent N, Throughput_{N} is the throughput of Agent N in terms of jobs per unit of time, and T is the time period over which jobs will be scheduled. Rcvd_{N} therefore represents the total number of jobs that can be scheduled for Agent N for execution during the next time period T.

The scheduler then compares the calculated value of Rcvd_{N} to the number of jobs that are available to be scheduled for processing by Agent N, defined as NJobs_{N}. If Rcvd_{N} is greater than or equal to the number of jobs that are to be scheduled for processing by Agent N, then all pending jobs (NJobs_{N}) can be scheduled, and Rcvd_{N} is updated as follows:

Rcvd_{N}=Rcvd_{N}−NJobs_{N} [3]

Where NJobs_{N} is the number of jobs to be scheduled for processing by Agent N.

On the other hand, if Rcvd_{N} is less than the number of jobs that are to be scheduled for processing by Agent N, then a number of jobs equal to Rcvd_{N} is submitted for processing. The difference between NJobs_{N} and Rcvd_{N} represents a number of jobs that are available but have not been sent to Agent N. Thus those jobs (NJobs_{N}−Rcvd_{N}) are queued by the scheduler until the next time interval.

At each time interval, the throughput of the agent is updated, and a new value of Rcvd_{N} is calculated. Accordingly, the total number of jobs that are submitted to the agent in each time unit should not exceed the available throughput of the agent at that time unit. Excess jobs are queued until the agent has throughput capacity to handle the jobs.

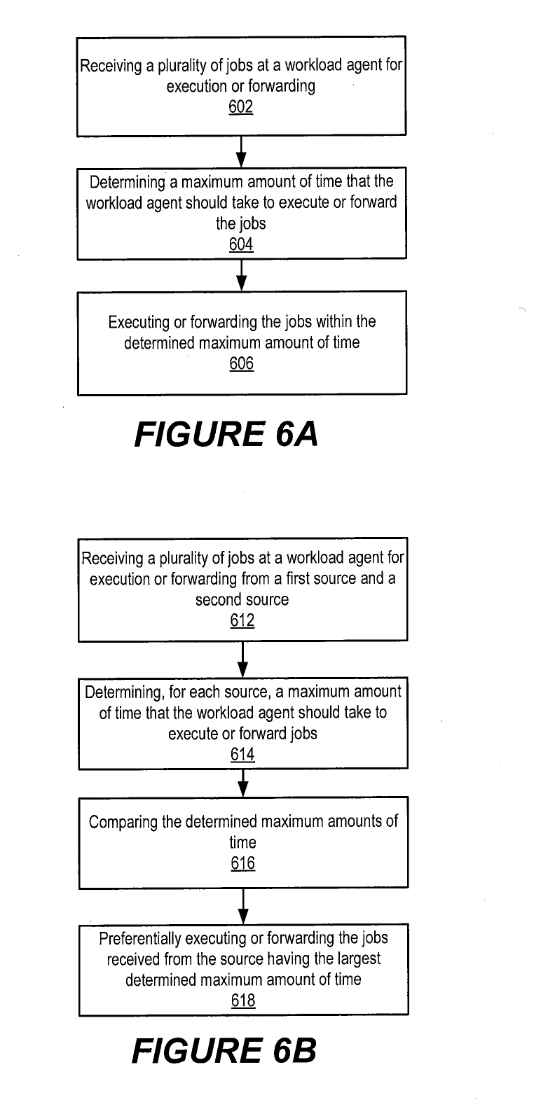

An example of the use of the Rcvd_{N} and NJobs_{N} variables to control job flow at an agent is illustrated in the table shown in FIG. 7, which is an example of workload flow control for a single agent. In FIG. 7, Rcvd_{N} is shown as “Rcvd” and NJobs_{N} is shown as “NJobs.” “ProcRate” represents the average throughput rate of the agent in the relevant time interval. Moreover, for purposes of simplicity, each time interval in the example of FIG. 7 represents one second.

Referring to FIG. 7, in the first second, the throughput of the agent is 100 jobs/s. Twenty-five jobs are received by the scheduler for scheduling at the agent, and there are no jobs queued for execution, so NJobs equals 25. Rcvd is calculated according to equation [2] to be 25. Thus, 25 jobs are sent to the agent for execution at the end of time interval 1.

In time interval 2, the throughput rate of the agent is still 100 jobs/s. Since all pending jobs were sent for execution in the previous time interval, there are no queued jobs at time interval 2. However, 200 more jobs arrived that are to be scheduled for the agent. Thus, the total number of jobs available to be scheduled is 200. However, according to equation [2], the value of Rcvd is only 100, so only 100 jobs are scheduled for the agent, and the remaining 100 jobs are shown in the next time interval as being queued.

In time interval 3, the throughput rate of the agent drops to 50 jobs/s. Because no new jobs are received, the total number of jobs to be scheduled is equal to the number of queued jobs, or 100. However, since Rcvd only evaluates to 50 according to equation [2], only 50 jobs are scheduled for execution by the agent, and the remaining 50 jobs are queued.

This process continues as additional jobs are received and processed until no jobs remain to be processed.

It will be appreciated that in equation [2], if the time interval over which the arrival rate is calculated is the same as the elapsed time since Rcvd was updated, then Rcvd simply equals the smaller of the number of jobs pending for execution in a given time interval and the number of jobs that the agent can process in the time interval. However, it will also be appreciated that the arrival rate can change over time, and the time intervals may not be equal.

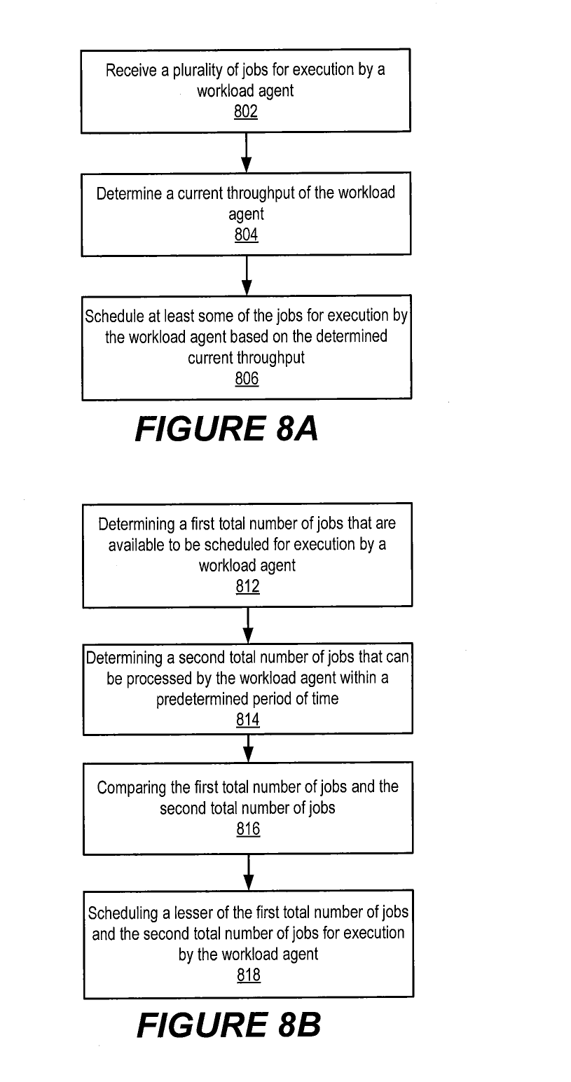

FIG. 8A is a flowchart of operations of a workload scheduling computer 100, or scheduler 100, for managing workloads at workload agents according to some embodiments. In particular, the scheduler 100 receives a plurality of jobs to be scheduled for execution by a workload agent (Block 802). The scheduler 100 determines a current throughput of the workload agent (Block 804), and schedules at least some of the plurality of jobs for execution by the workload agent in response to the determined current throughput of the workload agent (Block 806).

FIG. 8B illustrates the operation of scheduling at least some of the jobs for execution by the workload agent. In particular, the scheduler 100 first determines a first total number of jobs that are available to be scheduled for execution by the workload agent (Block 812). This value may be calculated as ElapsedTime_{N}*ArrivalRate_{N}+NQueued_{N} as described above. The scheduler then determines a second total number of jobs that can be processed by the workload agent within a predetermined time period based on the current throughput of the workload agent (Block 814). This may be calculated by multiplying Throughput_{N} by T, the length of the predetermined time period. The scheduler 100 then compares the first total number of jobs and the second total number of jobs (Block 816), and schedules a lesser of the first total number of jobs and the second total number of jobs for execution by the workload agent for execution within the predetermined time period (Block 818).

### Autonomous Forwarding of Jobs by Agents

As noted above, a broker component 104 of a workload scheduling computer 100 may send routing map information to a workload agent 120 that the workload agent can use to forward jobs to a downstream (e.g., secondary or tertiary) agent for processing. Some embodiments described herein enable a workload agent 120 to further manage its workload by autonomously forwarding jobs to downstream agents without requiring intervention or control by the broker 104. In particular, a scheduler 100 may generate a network topology of the entire network and transmit the network topology to one or more workload agents. The workload agents may generate routing maps based on the network topology and forward jobs along with routing maps to secondary workload agents of its choosing.

Initially, workload agents can register with the workload scheduling computer 100 to let the workload scheduling computer know that it is available to handle jobs. The workload scheduling computer 100 uses this information to build a network topology of agents that can handle jobs. The workload scheduling computer can then send a message to the workload agent to subscribe the workload agent to a particular scheduler. For example, a workload scheduling computer 100 (SERVER1) may send a subscription request to a workload agent (AGENT1) by sending a request message as follows:

20150708T18:33:11.234+00:00 AGENT1 SERVER1 MESSAGE1.0234
REQUEST SUBSCRIBE_SCH
SCHEDULER_ID:SERVER1
SCHEDULER_ADDRESS:HOST1
SCHEDULER_PORT:8999\hat{ }@

This message identifies the sender (SERVER1), and the receiver (AGENT1) in the header. The message contains a command (“REQUEST SUBSCRIBE_SCH”), and identifies the scheduler ID (“SCHEDULER_ID”), scheduler address (“SCHEDULER_ADDRESS”) and scheduler port (“SCHEDULER_PORT”) from which the workload agent will receives job requests.

The workload agent can respond back using a message indicating that the request is complete, as follows:

20150708T18:33:11.236+00:00 SERVER1 AGENT1 MESSAGE1.0234
RESPONSE STATE
STATUS:COMPLETE\hat{ }@

Note that the message identifies the message (“MESSAGE1.0234”) to which the response is provided. Once the workload agent has been subscribed, the workload scheduling computer 100 can send a request to the workload agent to perform a job, such as running a task. As an example, the workload scheduling computer 100 could send a command to the workload agent as follows:

20150708T18:33:11.534+00:00 AGENT1 SERVER1 MESSAGE1.0235
REQUEST EXEC
JOB_TYPE:COMMAND
CMD_NAME:CPUTest
CMD_ARGS:“-benchmark mode1 -time 6”\hat{ }@

This message includes a command (“REQUEST EXEC”) that requests the workload agent to execute an action identified by a job type (“JOB_TYPE”), which in this case is a COMMAND. Arguments for the command are given as key:value pairs in the payload as command name (“CMD_NAME”), which is “CPUTest”, with command arguments (“CMD_ARGS”) specified as “-benchmark mode1-time 6”.

Upon receipt of the job request, the workload agent would perform the assigned task and respond with a message indicating that the job is complete, such as the following:

20150708T18:33:11.542+00:00 SERVER1 AGENT1 MESSAGE1.0235
RESPONSE STATE
STATUS:COMPLETE\hat{ }@

Assuming that AGENT1 has reached a threshold capacity, AGENT1 may generate a forwarding map to allow the workload agent to forward the workload to a secondary workload agent. The agent may generate the forwarding map based on the network topology provided by the workload scheduling computer 100. The forwarding map may identify the primary workload agent (i.e., the agent generating the forwarding map), the host address of the primary workload agent and the port of the primary workload agent, along with the secondary workload agent, the host address of the secondary workload agent and the port of the secondary workload agent. The forwarding map may have the form: FORWARD_MAP:{{“AGENT_ID”:“<ID of primary workload agent>”, “AGENT_ADDRESS”:“<address of primary workload agent>”, “AGENT_PORT”:<port of primary workload agent>}:{“AGENT_ID”:“<ID of secondary workload agent>”, “AGENT_ADDRESS”:“<address of secondary workload agent>”, “AGENT_PORT”:<port of secondary workload agent>}}

For example, if a primary workload agent (AGENT1) has reached a threshold capacity, the primary workload agent may identify a secondary workload agent (AGENT2) that can handle a job assigned to the primary workload agent. The primary workload agent may send a message to the secondary workload agent having the following form:

20150708T18:33:11.534+00:00 AGENT1 AGENT2 MESSAGE1.0235
REQUEST EXEC
JOB_TYPE:COMMAND
CMD_NAME:CPUTest
CMD_ARGS:“-benchmark mode1 -time 6”
FORWARD_MAP:{{“AGENT_ID”:“Agent1”, “AGENT_ADDRESS”:“Host2”,
“AGENT_PORT”:5999}:{“AGENT_ID”:“Agent2”, “AGENT_ADDRESS”:“Host3”,
“AGENT_PORT”:6999}}\hat{ }@

The forwarding map is included in the payload of the message in a key:value format. The forwarding map can include a chain of additional agents (tertiary, quaternary, etc.) in addition to the primary and secondary workload agents. For example, a forwarding map may have a sequence such as: {{“AGENT_ID”:“Agent1”, “AGENT_ADDRESS”:“Host2”, “AGENT_PORT”:5999}:{“AGENT_ID”:“Agent2”, “AGENT_ADDRESS”:“Host3”, “AGENT_PORT”:6999}, {“AGENT_ID”:“Agent2”, “AGENT_ADDRESS”:“Host3”, “AGENT_PORT”:6999}:{“AGENT_ID”:“Agent3”, “AGENT_ADDRESS”:“Host4”, “AGENT_PORT”:9999}, . . . } where the pattern {{agent1}:{agent2},{agent2}:{agent3}, . . . } indicate that the message may be propagated from agent1 to agent2, from agent2 to agent3 and so on.

Upon receipt of the request, the secondary workload agent (AGENT2) identifies that it is the target agent by looking at the FORWARD_MAP and executes the job. The secondary workload agent sends the response back to the primary workload agent in a message including a reverse map identified by the payload key REVERSE_MAP. For example, the secondary workload agent may send a message such as the following to the primary workload agent:

20150708T18:33:11.542+00:00 AGENT1 AGENT2 MESSAGE1.0235
RESPONSE STATE
STATUS:COMPLETE
REVERSE_MAP:{{“AGENT_ID”:“Agent1”, “AGENT_ADDRESS”:“Host2”,
“AGENT_PORT”:5999}:{“AGENT_ID”:“Agent2”, “AGENT_ADDRESS”:“Host3”,
“AGENT_PORT”:6999}}\hat{ }@

The primary workload agent reads the reverse map and header, and forwards the response to the workload scheduling computer 100. The reverse map may be traced back in reverse order without the need for ordering the map for back propagation of the response. That is, the format {{agent1}:{agent2},{agent2}:{agent3}} may be interpreted as instructing message propagation from agent3 to agent2, and from agent2 to agent1, based on the REVERSE_MAP key.

In some embodiments, the primary agent may monitor the capacities of the other workload agents, and may determine that a secondary workload agent should be assigned to a particular workload agent for the performance of a particular task. In particular, the broker component 104 of the workload scheduling computer may send the primary agent a plurality of workload parameters from a plurality of workload agents. The workload parameters relate to available capacities of the plurality of workload agents, and may include parameters such as workload capacity, available CPU percentage, available memory, and/or available throughput. The parameters may be indicated by metrics, which may be absolute, relative, percentage, or any other suitable measure.

In this context, “workload capacity” means how many jobs can be processed by system in a given unit of time while maintaining a predetermined quality of service, such as a predetermined response time. For example, a particular workload agent can process 100 incoming jobs per second (i.e., 6000 jobs/hour or 1,44,000 jobs/day) while meeting a predetermined response deadline for each job, then workload capacity of the agent is at least 100 jobs per second.

The primary workload agent that is handling a job may identify a plurality of candidate secondary workload agents from among the plurality of workload agents in the network topology based on the plurality of workload parameters. Once the secondary workload agent has been identified, the primary workload agent builds a forwarding map to be transmitted to the secondary workload agent along with a job request.

The candidate secondary workload agents may be identified in part by determining path lengths from the primary workload agent to the plurality of workload agents. Path length may be determined in a number of ways. For example, path length may be determined based on a number of communication nodes between the primary workload agent and each of the plurality of workload agents, based on a bandwidth of communication channels between the primary workload agent and each of the plurality of workload agents, based on a round trip time (RTT) of messages between the primary workload agent and each of the plurality of workload agents, or other ways. Essentially, the best candidate secondary workload agent may be the workload agent that has the shortest communication path with the primary workload agent.

The candidate secondary workload agents may be selected as those workload agents that have a path length to the primary workload agent that is less than a threshold path length.

In some embodiments, the secondary workload agent may be identified by evaluating a selection function that mathematically evaluates the workload parameters.

For example, the secondary workload agent may be selected as the workload agent that maximizes a weight adjust factor (WAF) output by a function having the form:

$$WAF = \sqrt{\frac{{w}_{1} {M}_{1}^{2} + {w}_{2} {M}_{2}^{2} + {w}_{3} {M}_{3}^{2} + … + {w}_{N} {M}_{N}^{2}}{{w}_{1} + {w}_{2} + {w}_{3} + … + {w}_{N}}}$$

where M₁ . . . M_{N} are workload parameters, and w₁ . . . w_{N} are weights assigned to the respective workload parameters. The weighted selection function produces a WAF value that is based at least in part on the relative values of the workload parameters, as indicated by the weights w₁ . . . W_{N}. The weights may be assigned by the broker component 104. Moreover, the weights may be dynamically modified in response to feedback from the agents provided to the data collection function 106 of the workload scheduling computer 100.

TABLE 1
Example of Workload parameters and associated weights

| | | Value |
|---|---|---|
| Workload parameter | Weight | (normalized) |
| Workload capacity | 1.0 | 80 |
| Available CPU percentage | 0.8 | 60 |
| Available memory | 0.6 | 90 |
| Available throughput | 1.0 | 50 |

An example of workload parameters and associated weights, along with example values of the workload parameters, is shown in Table 1. The values of the workload parameters may be normalized values, percentages or raw values. Using the values in Table 1, which are normalized values, the WAF function shown above evaluates as follows:

$$WAF = \sqrt{\frac{( 1.0 ) {( 80 )}^{2} + ( 0.8 ) {( 60 )}^{2} + ( 0.6 ) {( 90 )}^{2} + ( 1.0 ) {( 50 )}^{2}}{1.0 + 0.8 + 0.6 + 1.0}} = 69.96$$

This WAF value may be compared to the WAF values of other candidate secondary workload agents to determine which of the candidate secondary workload agents should be selected as the secondary workload agent.

In some embodiments, the weights may be chosen so that the sum of weights is equal to unity. In that case, the following equation may be used to calculate WAF:

$$WAF = \sqrt{\frac{{w}_{1} {M}_{1}^{2} + {w}_{2} {M}_{2}^{2} + {w}_{3} {M}_{3}^{2} + … + {w}_{N} {M}_{N}^{2}}{{w}_{1} + {w}_{2} + {w}_{3} + … + {w}_{N}}}$$

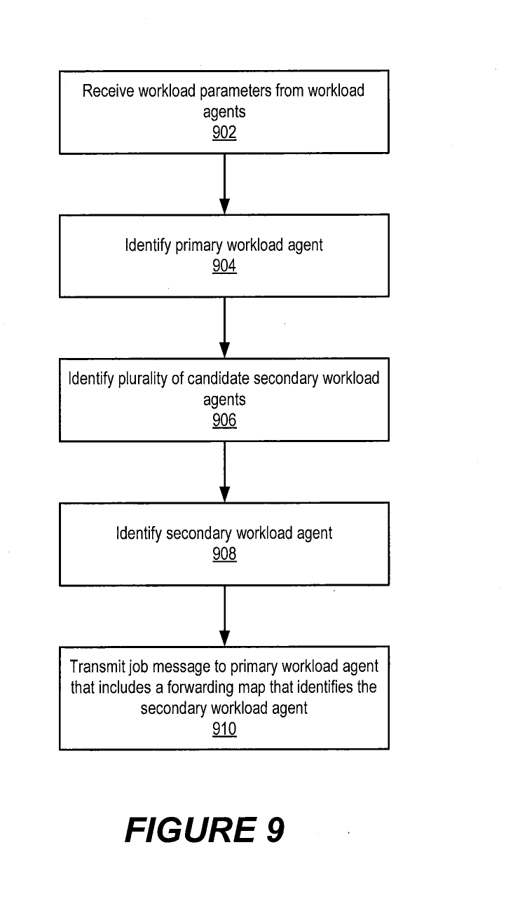

Operations of selecting candidate workload agents by a primary workload agent according to some embodiments are illustrated in the flowchart of FIG. 9. As shown therein, workload parameters are received for subscribed workload agents (block 902). As noted above, the workload parameters may include factors, such as workload capacity, available CPU percentage, available memory, and/or available throughput. When a job is to be forwarded by a primary workload agent, the primary workload agent may first identify a plurality of candidate secondary workload agents from among the workload agents in the network topology (block 906).

The primary workload agent then selects a secondary workload agent from among the candidate secondary workload agents (block 908). Finally, a job message is transmitted by the primary workload agent to the secondary workload agent (block 910). The job message includes a forwarding map that identifies the primary workload agent as the source of the job.

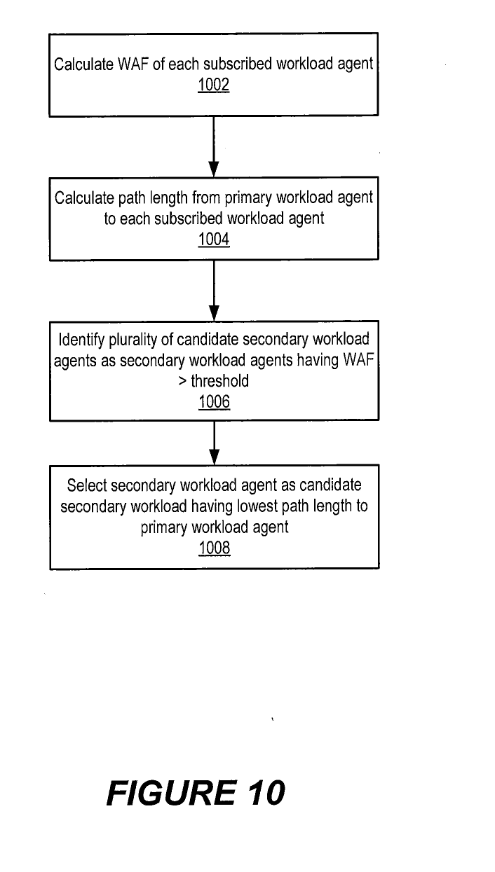

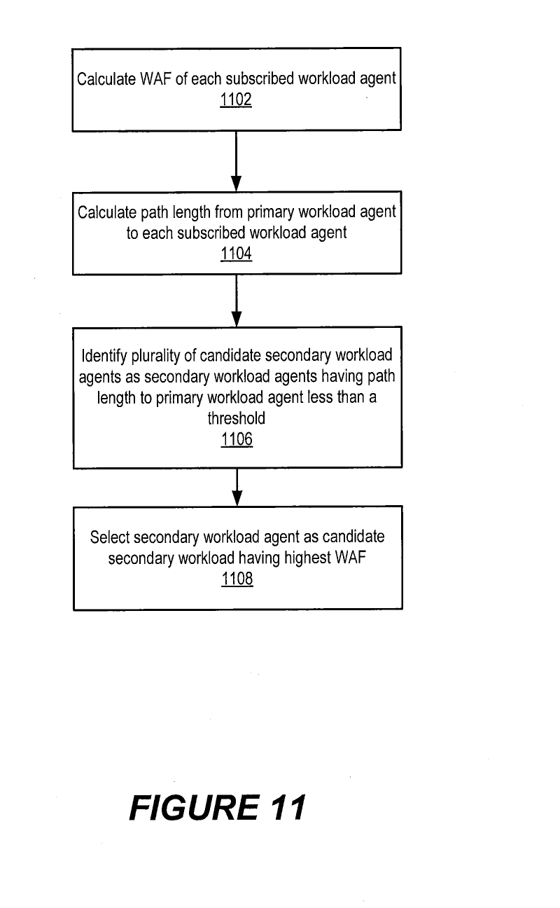

The identification of the candidate secondary workload agents and the selection of the secondary workload agent from among the candidate secondary workload agents can be performed in a number of ways, as illustrated in FIGS. 10 and 11.

Referring to FIG. 10, a value of WAF may be calculated for each subscribed workload agent (block 1002). In some embodiments, the broker component 104 may keep track of the WAF of each subscribed workload agent based on data reported to the data collection component 106 by the workload agents 120. Such data may be reported by the workload agents 120, for example, at regular intervals, in response to asynchronous queries by the data collection component 106, the broker 104, and/or along with responses to job requests. The agents may use this information to select a secondary workload agent.

The broker component 104 calculates a path length from the primary workload agent to each of the subscribed workload agents (block 1004). As noted above, the path length may be determined based on a number of communication nodes between the primary workload agent and each of the subscribed workload agents, based on a bandwidth of communication channels between the primary workload agent and the subscribed workload agents, based on a round trip time (RTT) of messages between the primary workload agent and the subscribed workload agents, or in other ways. One approach that can be used to measure distance over computer network is hop count, which refers to the number of intermediate nodes (such as routers, switches, gateways, etc.) through which data must pass between source and destination.

A simple hop count does not take into consideration the speed, load, reliability, or latency of any particular hop, but merely the total count. Accordingly, in some embodiments, the path length may be calculated as the sum of hops, where each hop is weighted based on factors, such as speed and/or latency. For example, path length L may be calculated as follows:

$$L = {\sum }_{i} \frac{{h}_{i} {S}_{i}}{{l}_{i}}$$

where hᵢ is a weight of the ith hop, Sᵢ is the speed of the ith hop (e.g., in Mbps), and lᵢ is the latency of the ith hop (e.g., in milliseconds). For example, assuming that there are two hops between a primary agent and a secondary agent having the characteristics shown in Table 2:

TABLE 2
Example of hop parameters and weights

| Hop | Weight | Speed (Mbps) | Latency (ms) |
|---|---|---|---|
| 1 | 1.0 | 5 | 2 |
| 2 | 1.0 | 10 | 5 |

then the path length L may be calculated as:

$$L = \frac{( 1.0 ) ( 5 )}{2} + \frac{( 1.0 ) ( 10 )}{5} = 4.5$$

This path length may be compared to path lengths towards other agents.

This information is communicated to the primary agent, which may then identify a group of candidate secondary workload agents from among the subscribed workload agents as those ones of the subscribed workload agents that have a value of WAF that exceeds a predetermined threshold (block 1006). The primary workload agent may then select the candidate secondary workload agent that has the shortest path length to the primary workload agent to be the secondary workload agent (block 1008).

In other embodiments, referring to FIG. 11, a value of WAF may be calculated for each subscribed workload agent (block 1102). The broker component 104 may calculate a path length from the primary workload agent to each of the subscribed workload agents (block 1104). These path lengths are communicated to the primary workload agent.

The primary workload agent may then identify a group of candidate secondary workload agents from among the subscribed workload agents as those ones of the subscribed workload agents that have a path length to the primary workload agent that is less than a predetermined threshold (block 1106). The primary workload agent may then select the candidate secondary workload agent that has the highest WAF to be the secondary workload agent (block 1108).

In some embodiments, the candidate secondary workload agents may be identified as those workload agents for which each of the workload parameters is greater than a respective threshold level. That is, the candidate secondary workload agents may include only those workload agents that have sufficient resources to perform the data processing task that is to be assigned to the primary workload agent.

For example, candidate secondary workload agents may be identified as those workload agents for which M₁≧M_{1,t}, . . . , M_{N}≧M_{N,t} where Mₙ is the nth workload parameter, and M_{n,t} is the threshold value of the nth workload parameter.

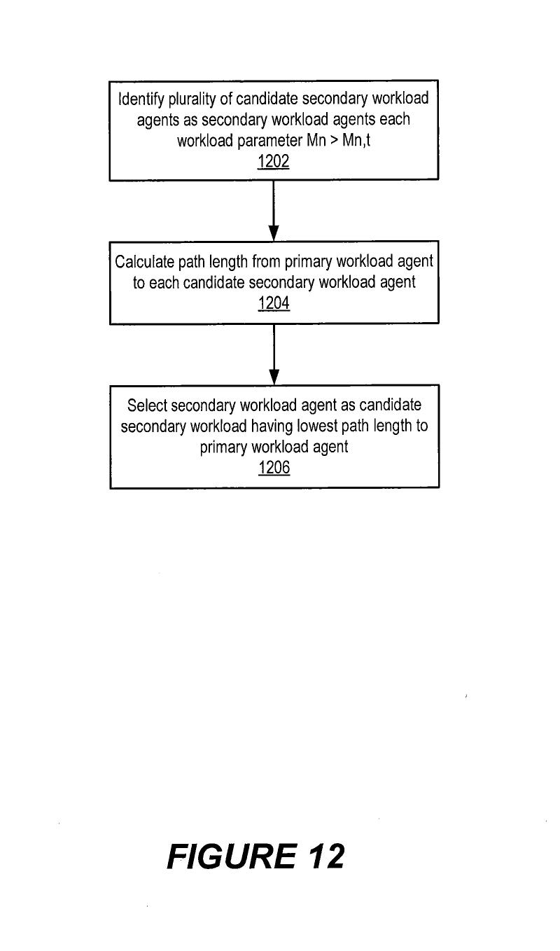

For example, referring to FIG. 12, the primary workload agent may identify those workload agents for which M₁≧M_{1,t}, . . . , M_{N}≧M_{N,t} as the candidate secondary workload agents (block 1202). The primary workload agent may calculate path lengths from the candidate secondary workload agents to the primary workload agent (block 1204), and select as the secondary workload agent the candidate secondary workload agent that has the shortest path length to the primary workload agent (block 1206).

According to further embodiments, the candidate secondary workload agents may also be selected based on information associated with the expected workload of a particular job. Such information is referred to herein as “job workload information.” The primary workload agent may receive receiving job workload information relating to the data processing task to be forwarded, and the candidate secondary workload agent may be selected based on the job workload information.

The job workload information may characterize a level of resources required by the data processing task. In particular, the job workload information may be used as the threshold values in the selection procedure illustrated in FIG. 12. For example, a particular job may have requirements for CPU availability, memory availability and throughput. In that case, the requirements for CPU availability, memory availability and throughput of the job may be used as the thresholds M_{n,t} for identifying the candidate secondary workload agents in block 1202, as discussed above.

The operations described above may be repeated to select a tertiary workload agent, a quaternary workload agent, etc. If a tertiary workload agent is selected, the forwarding map may identify the secondary workload agent and the tertiary workload agent.

### Workload Scheduling Computer and Computing Node Configurations

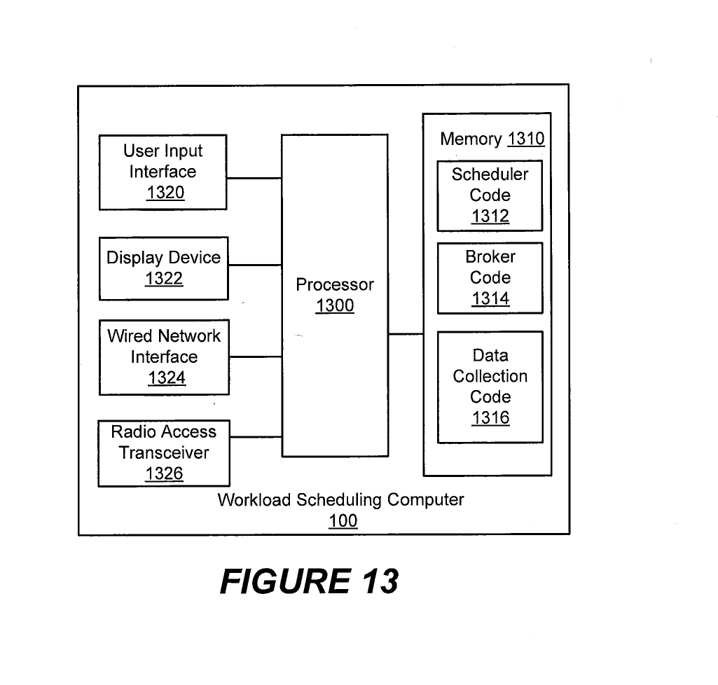

FIG. 13 is a block diagram of a device that can be configured to operate as the workload scheduling computer 100 according to some embodiments of the inventive concepts. The workload scheduling computer 100 includes a processor 900, a memory 910, and a network interface which may include a radio access transceiver 926 and/or a wired network interface 924 (e.g., Ethernet interface). The radio access transceiver 926 can include, but is not limited to, a LTE or other cellular transceiver, WLAN transceiver (IEEE 902.11), WiMax transceiver, or other radio communication transceiver via a radio access network.

The processor 900 may include one or more data processing circuits, such as a general purpose and/or special purpose processor (e.g., microprocessor and/or digital signal processor) that may be collocated or distributed across one or more networks. The processor 900 is configured to execute computer program code in the memory 910, described below as a non-transitory computer readable medium, to perform at least some of the operations described herein as being performed by an application analysis computer. The computer 900 may further include a user input interface 920 (e.g., touch screen, keyboard, keypad, etc.) and a display device 922.

The memory 910 includes computer readable code that configures the workload scheduling computer 100 to implement the job scheduler component 102, the broker component 104, and the data collection component 106 (FIG. 2). In particular, the memory 910 includes scheduler code 912 that configures the workload scheduling computer 100 to implement the job scheduler component 102, broker code 914 that configures the workload scheduling computer 100 to implement the broker component 104, and data collection code 914 that configures the workload scheduling computer 100 to implement the data collection component 106.

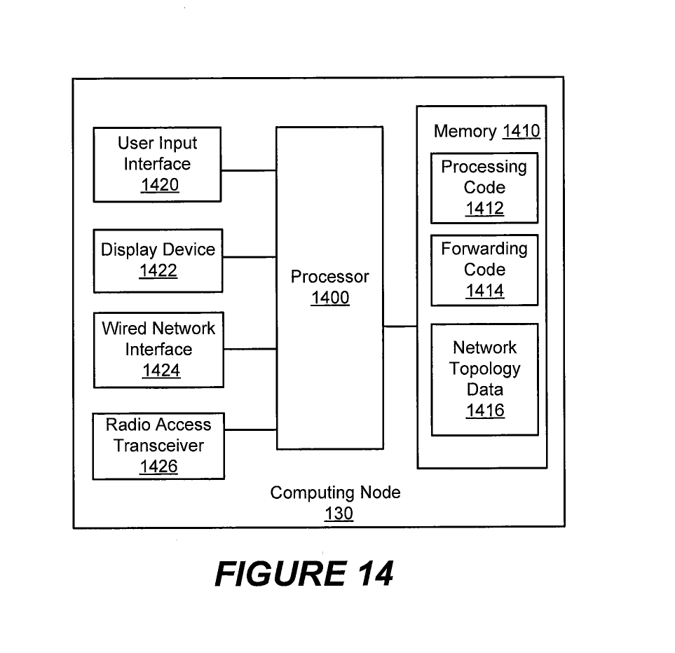

FIG. 14 is a block diagram of a computing node 130 that can be configured to host a workload agent 120 according to some embodiments of the inventive concepts. The computing node 130 includes a processor 1000, a memory 1010, and a network interface which may include a radio access transceiver 1026 and/or a wired network interface 1024 (e.g., Ethernet interface). The radio access transceiver 1026 can include, but is not limited to, a LTE or other cellular transceiver, WLAN transceiver (IEEE 902.11), WiMax transceiver, or other radio communication transceiver via a radio access network.

The processor 1000 may include one or more data processing circuits, such as a general purpose and/or special purpose processor (e.g., microprocessor and/or digital signal processor) that may be collocated or distributed across one or more networks. The processor 1000 is configured to execute computer program code in the memory 1010, described below as a non-transitory computer readable medium, to perform at least some of the operations described herein as being performed by an application analysis computer. The computer 1000 may further include a user input interface 1020 (e.g., touch screen, keyboard, keypad, etc.) and a display device 1022.

The memory 1010 includes computer readable code that configures the computing node 130 to implement a workload agent. In particular, the memory 1010 includes processing code 1012 that configures the computing node 130 to process jobs, forwarding code 1014 that configures the computing node 130 to forward jobs to neighboring agents, and network topology data 1014 that describes the network environment (e.g., paths and path lengths to neighboring agents).

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of a computing device:
receiving, at a workload agent, a plurality of jobs for processing by the workload agent;
determining a maximum amount of time that the workload agent should take to process the jobs; and
processing the jobs within the determined maximum amount of time.

2. The method of claim 1, wherein the maximum amount of time that the workload agent should take to process the jobs is determined based on a number of jobs received and a throughput of the workload agent.

3. The method of claim 1, wherein the maximum amount of time that the workload agent should take to process the jobs is calculated as follows:
ProcTime_{Y}=max(ProcTime_{Y},ElapsedTime_{Y})+(NJobs_{Y}/Throughput_{X})
where ProcTime_{Y} represents a maximum amount of time that the workload agent should take to process jobs received from a source Y, ElapsedTime_{Y} is an elapsed time since ProcTime_{Y} was reset, NJobs_{Y} is a number of jobs submitted by source Y that are currently being handled by the workload agent and Throughput_{X} is a throughput of the workload agent.

4. The method of claim 1, wherein the value of Throughput_{X} includes a workload capacity of the workload agent to execute jobs plus a rate at which the workload agent can forward jobs to a downstream agent.

5. The method of claim 3, further comprising resetting a value of ProcTimeY to zero in response to all jobs from source Y being either processed such that no remaining jobs from source Y are currently being handled by the workload agent.

6. The method of claim 3, further comprising updating a value of ProcTime_{Y} as jobs are received and processed.

7. The method of claim 1, wherein the source Y comprises a first source, the method further comprising determining a maximum amount of time that the workload agent should take to process jobs received from a second source X as follows:
ProcTime_{X}=max(ProcTime_{X},ElapsedTime_{X})+(NJobs_{X}/Throughput_{X})
where ProcTime_{X} represents a maximum amount of time that the workload agent should take to process jobs received from the second source X, ElapsedTime_{X} is an elapsed time since ProcTime_{X} was reset, and NJobs_{X} is a number of jobs submitted by the second source X that are currently being handled by the workload agent.

8. The method of claim 7, further comprising:
comparing a value of ProcTime_{X} to a value of ProcTime_{Y}, and preferentially processing jobs submitted by the source having the largest value of ProcTime.

9. The method of claim 8, further comprising:
if the value of ProcTime_{X} is equal to the value of ProcTime_{Y}, comparing values of ElapsedTime_{X} and ElapsedTime_{Y} and preferentially processing jobs submitted by the source having the largest value of ElapsedTime.

10. A method, comprising:
performing operations as follows on a processor of a computing device:
receiving, at a workload scheduler, a plurality of jobs to be scheduled for execution by a workload agent;
determining a current throughput of the workload agent;
determining a first total number of jobs that are available to be scheduled for execution by the workload agent;
determining a second total number of jobs that can be processed by the workload agent within a predetermined time period based on the current throughput of the workload agent;
comparing the first total number of jobs and the second total number of jobs; and
scheduling a lesser of the first total number of jobs and the second total number of jobs for execution by the workload agent for execution within the predetermined time period.

11. The method of claim 10, wherein comparing the first total number of jobs and the second total number of jobs comprises calculating a value as follows:
Rcvd_{N}=min(ElapsedTime_{N}*ArrivalRate_{N}+NQueued_{N},Throughput_{N}*T)
where ElapsedTime_{N} is an elapsed time since Rcvd_{N} was updated, ArrivalRate_{N} is an average arrival rate of jobs to be scheduled at the workload agent, NQueued_{N} is a number of jobs previously queued for execution by the workload agent, Throughput_{N} is a throughput of the workload agent, and T is a time period over which jobs will be scheduled.

12. The method of claim 11, further comprising updating a value of Rcvd_{N} as jobs are scheduled for execution by the workload agent.

13. A method, comprising:
performing operations as follows on a processor of a computing device:
receiving at a primary workload agent, via a communication network, a job to be executed by the primary workload agent;
receiving a plurality of workload parameters for a plurality of workload agents, wherein the workload parameters relate to available capacities of the plurality of workload agents and wherein the workload agents comprise computing nodes configured to perform data processing tasks;
identifying a plurality of candidate secondary workload agents from among the plurality of workload agents;
identifying a secondary workload agent from among the plurality of candidate secondary workload agents based on the plurality of workload parameters; and
transmitting, via the communication network, a job message that contains a command for the secondary workload agent to perform a data processing task, wherein the job message includes a forwarding map that identifies the primary workload agent and that instructs the secondary workload agent to perform the data processing task.

14. The method of claim 13, wherein identifying the plurality of candidate secondary workload agents comprises determining path lengths from the primary workload agent to the plurality of workload agents based on a number of communication nodes between the primary workload agent and each of the plurality of workload agents, and selecting workload agents having a path length to the primary workload agent that is less than a threshold path length as the candidate secondary workload agents.

15. The method of claim 13, wherein identifying the secondary workload agent comprises evaluating a selection function that mathematically evaluates the workload parameters.

16. The method of claim 15, wherein the selection function comprises a weight adjusted function of the plurality workload parameters.

17. The method of claim 15, wherein the plurality of workload parameters comprise an available CPU metric, an available memory metric, an available workload capacity metric, and/or an available throughput metric.

18. The method of claim 15, wherein evaluating the selection function comprises selecting a workload agent from among the candidate secondary workload agents that maximizes a weight adjust factor (WAF) output by a function based on:
$$WAF = \sqrt{\frac{{w}_{1} {M}_{1}^{2} + {w}_{2} {M}_{2}^{2} + {w}_{3} {M}_{3}^{2} + … + {w}_{N} {M}_{N}^{2}}{{w}_{1} + {w}_{2} + {w}_{3} + … + {w}_{N}}}$$
where M₁ . . . M_{N} are workload parameters, w₁ . . . w_{N} are weights assigned to the respective workload parameters.

19. The method of claim 18, wherein identifying the candidate secondary workload agents comprises identifying workload agents for which each of the workload parameters is greater than a respective threshold level.
